(19) United States
(12) Patent Application Publication
(10) Pub. No.: US 2022/0224802 A1
(43) Pub. Date: Jul. 14, 2022

(54) IMAGE PROCESSING OF FORM DOCUMENT

(71) Applicant: Hewlett-Packard Development Company, L.P., Spring, TX (US)

(72) Inventors: Janggeun KIM, Seongnam-si (KR); Shincheol LIM, Seongnam-si (KR)

(21) Appl. No.: 17/605,767

(22) PCT Filed: Jun. 3, 2020
(86) PCT No.: PCT/US2020/035879

§ 371 Date: Oct. 22, 2021

(30) Foreign Application Priority Data
Dec. 6, 2019 (KR) 10-2019-0161235

(51) Int. Cl. H04N 1/387; H04N 1/00; H04N 1/32; G06F 40/174

(52) U.S. Cl. CPC H04N 1/387; H04N 1/00212; H04N 1/32475; H04N 2201/3243; H04N 1/00411; H04N 1/00244; H04N 2201/325; G06F 40/174

(57) ABSTRACT

An example image forming device includes a scanner to scan a form document to generate a document image, and a processor to generate information data by converting written information with respect to at least one fill-out item of the form document into image data that can be written in the document image, and generate final document image data by combining the information data with document image data based on the document image.

### BACKGROUND

A user may print a form in order to fill in user information by writing down the necessary information by hand. Forms completed in this manner may be collected, converted into a file through scanning, and stored.

### BRIEF DESCRIPTION OF THE DRAWINGS

Various examples will be described below by referring to the following figures.

FIG. 1 shows an image forming device according to an example.

FIG. 2 and FIG. 3 are flowcharts of a form document completion method according to an example.

FIG. 4 is a flowchart of a form document completion method according to an example.

FIG. 5 shows an image forming device, a user terminal, and a universal serial bus (USB) memory according to an example.

FIG. 6 is a flowchart of a user terminal according to an example.

FIG. 7 is a flowchart of a processor according to an example.

### DETAILED DESCRIPTION OF EXAMPLES

As those skilled in the art will realize, the following described examples may be modified in various different ways, all without departing from the spirit or scope as defined by the following claims.

In the following description, parts that are not relevant may be omitted, and the same elements or equivalents are referred to by the same reference numerals throughout the specification.

In addition, unless explicitly described to the contrary, the word “comprise” and variations such as “comprises” or “comprising” will be understood to imply the inclusion of stated elements but not the exclusion of any other elements.

In addition, the terms “-er”, “-or”, and “module” described in the specification refer to units for processing at least one function and operation, and can be implemented by hardware components, software components, or a combination thereof.

A server and a device hereinafter described may each be configured with at least one processor, a memory, and a communication apparatus as its hardware, and a program performed in combination with hardware may be stored in a designated location. The hardware has a configuration for performing a method according to various described examples. The program includes instructions for implementing an operation method according to various examples as described with reference to drawings, and the examples may be performed in combination with hardware such as a processor or a memory.

In the described examples, “transmission or provision” may include indirect transmission or provision via another device or by use of a bypass in addition to direct transmission or provision.

In the described examples, an expression recited in the singular may be construed as singular or plural unless the expression “one”, “single”, etc. is used.

In the described examples, regardless of the drawing, the same reference numbers refers to the same constituent elements, and “and/or” includes all combinations of each and at least one of the constituent elements mentioned.

In the flowcharts described with reference to the drawings in this specification, the operation order may be changed, various operations may be merged, certain operations may be divided, and certain operations may not be performed.

In order to fill out information for a particular form, a writer may print out the form as a document, fill out the information, scan the filled out form, and save the scanned image as a file. For example, to fill out information such as a contractor's name, contact information, an address, a signature, and the like in a contract form document, and save it as a file, the contractor may print out the form document, fill out the contractor's personal information in the document, scan the document, and store the scanned document as a file.

Accordingly, an unnecessary output is generated by the printing of the document for the writer to fill-out, thereby causing use of consumables such as paper and toner. In addition, when the same information needs to be included in several places on the form, the writer has to provide the same information several times.

In various examples, when filling out and storing information of a plurality of unspecified individuals in a form, personal information of a writer may be transmitted in a format with the writer's consent without unnecessary printing, and the personal information that corresponds to an area of the form document can be automatically filled out and stored as a file.

Hereinafter, an example will be described with reference to the accompanying drawings.

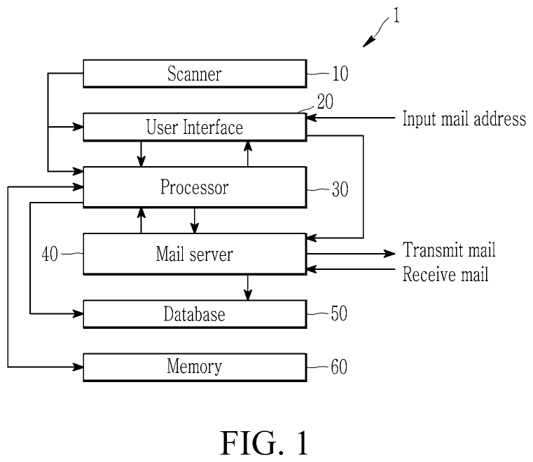

FIG. 1 shows an image forming device according to an example.

Referring to FIG. 1, an image forming device 1 includes a scanner 10, a user interface 20, a processor 30, a mail server 40, a database 50, and a memory 60.

The scanner 10 may scan a form document to generate a document image.

The user interface 20 may display a document image. A user may select an item (e.g., a blank, a section, or the like) that a writer needs to complete to fill out the form document from the displayed document image. In addition, the user interface 20 may display a list (hereinafter, referred to a fill-out item list) that summarizes the items that need to be filled out, together with the document image.

The user may input mail addresses of a plurality of unspecified individuals through the user interface 20, and the mail addresses may be transmitted to the mail server 40 from the user interface 20 and stored in the database 50. The user interface 20 may provide various option menus for a user's convenience such as a file storage, a file storing method, and the like.

The processor 30 may control an operation of the image forming device 1, and may be any of various types of processors that process instructions included in programs. For example, the processor 30 may be a central processing unit (CPU), a microprocessor unit (MPU), a microcontroller unit (MCU), a graphics processing unit (GPU), and the like. The processor 30 may execute a program that includes instructions described to perform an operation according to an example.

The memory 60 may load a corresponding program such that the instructions described to perform an operation according to an example can be processed by the processor 30. The memory 60 may be, for example, a read only memory (ROM), a random access memory (RAM), and the like. The processor 30 executes instructions of programs loaded in the memory 60. That is, a program loaded in the memory includes instructions that the processor 30 may execute, such as example operations to be described hereinafter.

The processor 30 receives a document image scanned by the scanner 10. In an example, the processor 30 may generate character data that indicates characters written in the document by optical character reader (OCR) processing of the document image. In an example, the processor 30 may convert the document image to document image data that can be used in the processor 30 by image processing of the document image.

The processor 30 may analyze document image data and extract an item that needs to be filled out to generate a fill-out item list or may generate a list of fill-out items selected by the user.

For example, the processor 30 may detect fill-out fields by analyzing document image data, determine an item adjacent to the detected fill-out field as a fill-out item corresponding to the fill-out field, and generate a list of fill-out items by collecting the corresponding items.

The processor 30 may extract a location and a size of a fill-out field that needs to be filled out by a writer for each of selected fill-out items among the fill-out item list.

For example, the processor 30 may analyze the document image data to detect a location and a size of the fill-out field of each of the selected fill-out items such that the location and the size of the fill-out field can correspond to each fill-out item.

Alternatively, the processor 30 may receive fill-out items selected by the user through the user interface 20, may extract a location and a size of a fill-out field of each of the selected fill-out items, and may analyze document image data to correspond to each of the selected fill-out items to a location and a size of the corresponding fill-out field for each fill-out item. The user may select a location of the fill-out field through the user interface 20. In this case, the processor 30 may extract the size of the fill-out field based on the location of the fill-out field.

In addition, the processor 30 may extract a signature location and a signature fill-out area when a signature is required in the form document. The processor 30 may extract a signature location by analyzing the document image data, and may extract a predetermined area as a signature fill-out area with reference to the signature location.

The processor 30 may generate mail body data based on fill-out items and transmit the data to the mail server 40. For example, the processor 30 may generate the mail body data by using character data that indicates fill-out items, or by extracting areas that indicate fill-out items in the document image. In addition, the processor 30 may include content that requests a writer's signature in the mail body data.

The processor 30 may selectively extract information (hereinafter, referred to as written information) filled out for each fill-out item of mail received from the mail server 40, and may generate information data by converting the extracted written information as image data, which can be written in the document image. In this case, when the processor 30 receives a signature image, the processor 30 may generate signature data by converting the signature image into image data, which can be written in a document image. In this case, the processor 30 may generate information data according to the size of the fill-out field, and generate signature data by upscaling or downscaling the signature image according to the size of the signature fill-out area.

The processor 30 may combine corresponding information data according to a fill-out location and a size with the document image data. When a signature is provided, the processor 30 may overwrite signature data to a document image data area that corresponds to the signature location and the signature fill-out area such that final document image data in which the form document is filled out can be generated.

For example, the processor 30 may combine image data with addresses that respectively correspond to locations and sizes of fill-out fields in one image data frame, which indicates one frame (e.g., one page of a predetermined size) of a document image. If a signature is provided, the processor 30 may overwrite signature data to an address that corresponds to a signature location and a signature fill-out area such that image data of the frame is completed. When the document image includes a plurality of frames, the processor 30 may perform the same operation with respect to image data corresponding to each frame. As described, the processor 30 generates final document image data by using document image data, information data, and signature data if provided, and transmits the final document image data to the database 50 for each writer.

The mail server 40 receives mail body data from the processor 30, generates a mail body based on the mail body data, receives a scan image from the scanner 10, attaches the scan image to the mail, and sends information fill-out request mail to mail addresses input through the user interface 20. When response mail with respect to the information fill-out request mail is received, the mail server 40 may transmit the received response mail to the processor 30. Signature mail of a writer may be attached to the received response mail, and the mail server 40 may transmit the received response mail and a signature file to the processor 30.

The database 50 receives fill-out item related data including at least one of image data of a scanned document image, an extracted fill-out item list, selected fill-out items, data related to a location and a size of a fill-out field, or signature-related data that includes data related to a location of a signature and a signature fill-out area, and stores the fill-out item related data and the signature related data for each form document. In addition, the database 50 may store the fill-out item related data and the signature related data in association with image data of a document image. The database 50 receives information data and signature data from the processor 30 and stores the received data in associated with a document image for each writer. The database 50 receives final document image data with respect to all writers from the processor 30 and stores the received data for each writer.

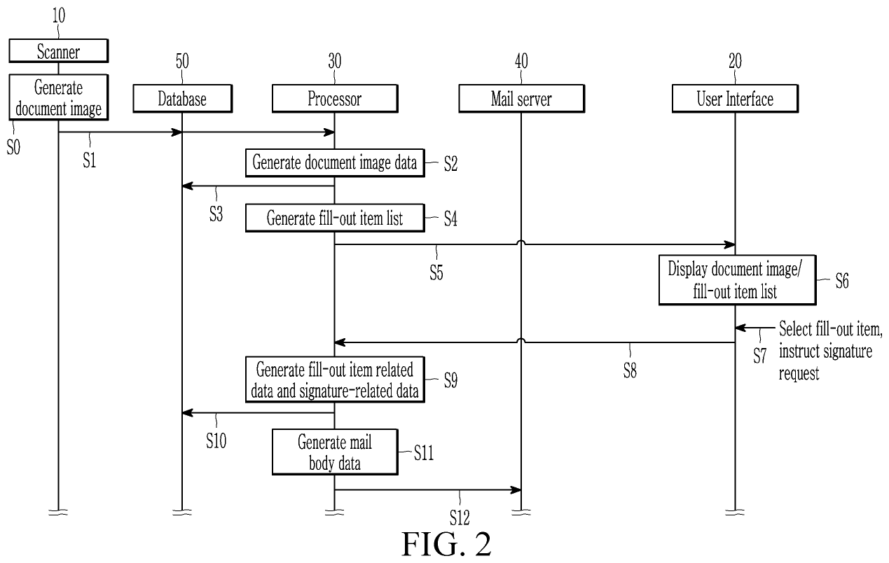

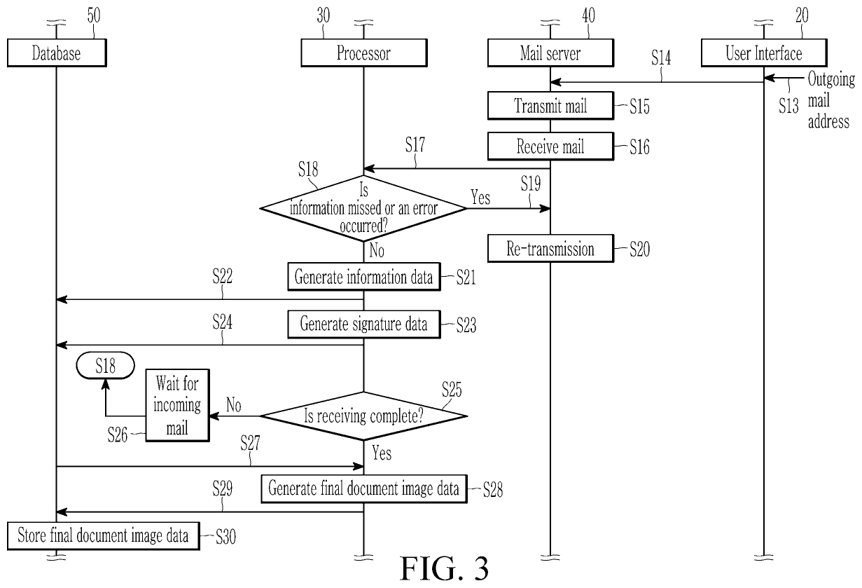

Hereinafter, a form document completion method according to an example will be described with reference to FIG. 2 and FIG. 3.

FIG. 2 and FIG. 3 are flowcharts of a form document completion method according to an example.

Referring to FIG. 2, the scanner 10 scans a form document to generate a document image in operation SO. The scanner 10 may transmit the document image to the database 50 or the processor 30 in operation S1.

The processor 30 generates character data by OCR processing the document image, or converts the document image to document image data that can be used in the processor 30 by image-processing the document image in operation S2. The processor 30 may transmit the document image data to the database in operation S3. The database 50 may store the document image data.

The processor 30 may extract an item to be filled out by analyzing the document image data to generate a fill-out item list in operation S4.

The processor 30 transmits the document image data and the fill-out item list to the user interface 20 in operation S5.

The user interface 20 may display a document image through a display, and may display the fill-out item list together in operation S6.

In operation S7, the user interface 20 receives a user selection of fill-out items to be filled out from the fill-out item list displayed by the user interface 20. In operation S7, a user selection or an instruction by the user (i.e., a signature request instruction) that requests obtaining of a signature from a writer may also be received by the user interface 20.

The user interface 20 transmits fill-out items selected by the user and the signature request instruction to the processor 30 in operation S8.

The processor 30 generates fill-out item related data that includes the selected fill-out items and locations and sizes of the respective fill-out items. When a signature request is instructed, the processor 30 may generate signature related data that includes a signature location and a signature fill-out area in operation S9.

The processor 30 may transmit the fill-out item related data and the signature related data to the database 50 in operation S10. The database 50 may store the received fill-out item related data and the signature related data in association with document image data.

The processor 30 may generate mail body data that includes received fill-out items in operation S11. When the signature request is instructed, the processor 30 may include a signature request in the mail body data. The processor 30 transmits the mail body data to the mail server 40 in operation S12.

Referring to FIG. 3, outgoing mail addresses are input through the user interface 20 by a user in operation S13. The user interface 20 may transmit the input outgoing mail addresses to the mail server 40 in operation S14. Alternatively, outgoing mail addresses may be input in advance by a user through the user interface 20, the database 50 may store the outgoing mail addresses, and the mail server 40 may read the outgoing mail addresses from the database 50.

The mail server 40 attaches a scanned document image to mail to be sent to the received outgoing mail addresses and may transmit the mail, of which a main body is written based on the mail body data, in operation S15. In an example of operation S15, the mail server 40 may read a document image stored in the database 50 or may receive a document image from the scanner 10.

In operation S16, the mail server 40 receives mail from the outgoing mail addresses after sending the mail in operation S15. The mail server 40 transmits the received mail to the processor 30 in operation S17.

The processor 30 determines whether there is missed information or an error in the main body of the received mail in operation S18.

As a result of the determination in S18, when missed information or an error is detected, the processor 30 informs the mail server 40 of the missed information or error to the corresponding mail address and requests re-sending of mail from the mail server 40 in operation S19.

The mail server 40 generates mail that includes a main body indicating missing information or an error, and re-sends the generated mail to the corresponding mail address in operation S20.

As a result of the determination in S18, when there is no missing information or error, the processor 30 selectively extracts written information, and may generate information data by image-processing the extracted written information in operation S21.

The processor 30 may send the information data to the database 50 in operation S22.

When receiving a signature image, the processor 30 may image-process the signature image to generate signature data in operation S23.

The processor 30 may send the signature data to the database 50 in operation S24.

The processor 30 may determine whether all incoming mail with respect to the outgoing mail has been received in operation S25.

When it is determined that the receiving of the incoming mail has not been fully completed in S25, the processor 30 waits for incoming mail from the mail server 40 in operation S26, and returns to operation S18 to receive the incoming mail.

When it is determined that the receiving of the incoming mail has been fully completed in operation S25, the processor 30 may receive (e.g., read) document image data, fill-out item related data, and image data, and, if a signature is provided, signature related data and signature data, from the database 50 in operation S27.

The processor 30 combines information data that corresponds to a fill-out location and a size with the document image data, and, when a signature is provided, the processor 30 overwrites the signature data to a document image according to a signature location and a signature fill-out area such that final document image data of which the form document is filled out can be generated in operation S28.

The processor 30 generates final document image data with respect to all writers and sends the generated final document image data to the database 50 in operation S29.

The database 50 may classify and store the final document image data for each writer in operation S30.

In FIG. 3, it is described that the final document image data is generated when the processor 30 has completed the receiving of mail from the outgoing mail addresses. However, the final document image data may be generated whenever the processor 30 receives the mail from the outgoing mail addresses.

In FIG. 2, it is described that the processor 30 generates the fill-out item list by analyzing the document image data. However, in an example, a fill-out item may be directly input from a user through the user interface 20. When the fill-out item is input by the user through the user interface 20, a fill-out location can also be input.

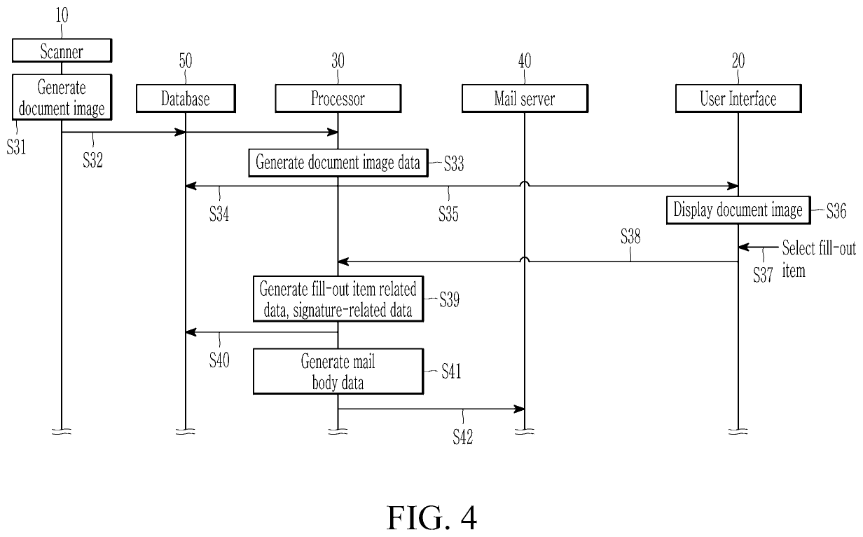

FIG. 4 is a flowchart of a form document completion method according to an example.

Referring to FIG. 4, the scanner 10 may generate a document image by scanning a form document in operation S31. The scanner 10 may transmit the document image to the database 50 and the processor 30 in operation S32.

The processor 30 generates character data by OCR processing the document image or converts the document image to document image data that can be used in the processor 30 by image-processing the document image in operation S33. The document image data may be transmitted to the database 50 and stored therein in operation S34.

The processor 30 transmits the document image data to the user interface in operation S35.

The user interface 20 may display a document image through a display in operation S36.

Items that need to be filled out may be selected by a user from the document image displayed through the user interface 20 in operation S37. In operation S37, at least one of a location of a fill-out field of each fill-out item and an instruction that requests a signature from a writer (i.e., a signature request instruction) may be input through the user interface 20, together with the fill-out items.

The user interface 20 transmits at least one of the fill-out items selected by the user, the location of the fill-out field, and the signature request instruction to the processor 30 in operation S38.

In operation S39, the processor 30 generates fill-out item related data that includes selected fill-out items, locations of the fill-out items, and sizes of fill-out fields. When a signature request is instructed, the processor 30 may generate signature related data that includes a signature location and a signature fill-out area.

The processor 30 may transmit the fill-out item related data and the signature related data to the database 50 in operation S40. The database 50 may store the received fill-out item related data and the signature related data in association with document image data.

The processor 30 may generate mail body data that includes received fill-out items in operation S41. When receiving a signature request instruction, the processor 30 may include a signature request in the mail body data. The processor 30 transmits the mail body data to the mail server 40 in operation S42.

The mail server 40 generates a mail body based on the mail body data, transmits mail to outgoing mail addresses, receives mail from the outgoing mail addresses, and transmits the received mail to the processor 30. Example operations after transmitting the received mail to the processor 30 may be the same as the operations described with reference to FIG. 3.

The order of each operation shown in FIG. 2 to FIG. 4 is provided to illustrate an example. However, the order of each operation can be performed simultaneously with other operations in a range that does not affect the other operations, or the order of each operation can be changed.

In the descriptions of examples provided hereinabove with reference to FIG. 1 to FIG. 4, a network function is provided by using the mail server provided in the image forming device. However, an example using a processor provided in the user terminal and a movable storage device may be implemented even through there is no configuration for providing a network function in the image forming device. Hereinafter, although an example uses a universal serial bus (USB) memory as a movable storage device. However, another movable storage device may be used.

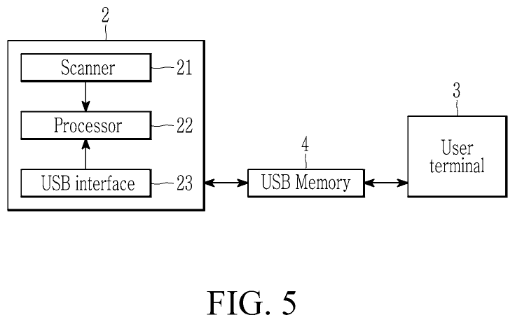

FIG. 5 shows an image forming device, a user terminal, and a USB memory according to an example.

Referring to FIG. 5, a user terminal 3 may send mail that includes fill-out items that need to be filled out in a form document to an outgoing mail address of a writer, may receive mail that includes written information with respect to the fill-out items, and may copy the written information to a USB memory 4.

An image forming device 2 may read information from the USB memory 4 to generate final document image data and may store the final document image data in the USB memory 4.

As illustrated in the example of FIG. 5, the image forming device 2 includes a scanner 21, a processor 22, and a USB interface 23. However, FIG. 5 illustrates only a configuration for description of an example and the image forming device 2 may include other hardware configurations.

The scanner 21 scans a document, such as a form document, and generates a document image.

The USB interface 23 may transmit/receive data and a control signal to/from an external device by following the USB communication standard. The USB memory 4, which is an external device, may be connected through the USB interface 23.

The processor 22 receives a document image scanned by the scanner 10, and generates character data that indicates characters written in the document by optical character reader (OCR) processing of the document image or converts the document image to document image data that can be used in the processor 30 by image processing the document image.

The processor 22 reads written information for each fill-out item and fill-out item related information from the USB memory 4 through the USB interface 23, and converts the read written information to image data that can be filled in a document image to generate information data. The processor 22 reads signature related information if a signature image is provided and converts the signature image to image data that can be filled in the document image to generate signature data.

The processor 22 combines information data that corresponds to a location and a size of a fill-out field of each fill-out item based on the fill-out item related information with document image data, and, if a signature is provided, the processor 22 overwrites the signature data to the document image data according to a signature location and a signature fill-out area based on the signature related information to generate final document image data. An example of a method for generating the final document image data is the same as the process of the above-described example, and therefore a duplicated description will not be provided.

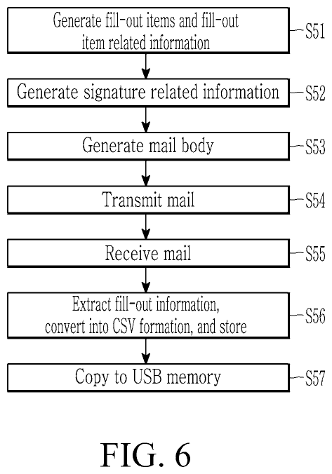

FIG. 6 is a flowchart of a user terminal according to an example.

Referring to FIG. 6, the user terminal 3 generates fill-out items that need to be filled out in a form document according to an input of a user and fill-out item related information that is related to a location of a fill-out field and a size of the fill-out field for each fill-out item in operation S51.

When a form document is to be signed according to an input of the user, the user terminal 3 generates signature related information that relates to a signature location and a signature fill-out area according to the user's input in operation S52.

The user terminal 3 generates a mail body based on fill-out items in operation S53. When a signature is required, the user terminal 3 may include content that requests a signature in the mail body.

Mail generated by the user terminal 3 is transmitted to an outgoing mail address in operation S54.

The user terminal 3 receives mail from the outgoing mail address in operation S55.

The user terminal 3 may extract information filled out by a writer for each fill-out item from the received mail, may convert the extracted information in a comma-separated values (CSV) format, and may store the converted information in operation S56. The CSV format is an example of a file format for storing extracted information, and examples are not limited thereto.

The CSV format information stored in the user terminal 3 is copied to the USB memory 4 in operation S57. In this case, when a signature image is included in the fill-out item related information and the received mail, the signature image and signature related information may be copied to the USB memory 4.

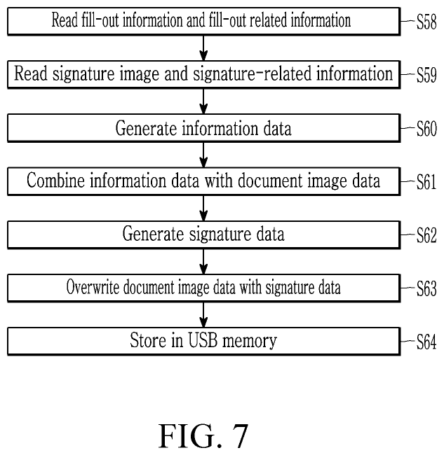

FIG. 7 is a flowchart of a processor according to the example.

Referring to FIG. 7, the processor 22 of the image forming device 2 may read information filled out for each fill-out item and information related to fill-out items from the USB memory 4 through the USB interface 23 in operation S58.

When a signature image is provided, the processor 22 may read the signature image and signature related information together from the USB memory 4 in operation S59.

The processor 22 may generate information data by converting the written information into image data that can be filled in a document image in operation S60.

The processor 22 may combine the corresponding information data with the document image data according to the location and size of the fill-out field of each fill-out item based on the fill-out item related information in operation S61.

When a signature image is provided, the processor 22 may generate signature data by converting the signature image into image data that can be filled in the document image in operation S62.

The processor 22 may overwrite the document image data with the signature data according to the signature location and the signature fill-in area based on the signature related information in operation S63.

The processor 22 may store the generated final document image data in the USB memory 4 through the USB interface 23 in operation S64.

In FIG. 5 to FIG. 7, an example of using the user terminal 3 and the USB memory 4 is described. However, an example data transmitting/receiving method between the image forming device 2 and the user terminal 3 is not limited thereto.

For example, a mobile terminal and the image forming device may be connected with each other through a near filed communication (NFC) tagging function of the mobile terminal to transmit written information, fill-out item related information, a signature image, signature related information, and the like. In another example, the written information, fill-out item related information, a signature image, signature related information, and the like can be transmitted to the mobile terminal from the user terminal through data communication using a WIFI-direct connection between the user terminal and the mobile terminal. The mobile terminal may transmit information and images received from the user terminal to the image forming device. The image forming device may generate final document image data, may transmit the generated document image data to the mobile terminal, and the mobile terminal may transmit the received document image data back to the user terminal.

Alternatively, the user terminal may transmit mail to the outgoing mail address, and a cloud server may receive mail from the outgoing mail addresses, thereby generating the written information, the fill-out item related information, a signature image, signature related information, and the like, and may transmit the generated information to the mobile terminal. The mobile terminal may transmit the received information to the image forming device through the NFC tagging function, the image forming device may generate final document image data and transmit the same to the mobile terminal, and the mobile terminal may transmit the final document image data back to the cloud server. The cloud server may transmit the final document image data to the user terminal.

Conventionally, there is an image forming device that provides a function of automatically filling in personal information. However, because a plurality of pieces of information of a plurality of specified individuals managed by a server can be utilized, information of a plurality of unspecified individuals cannot be utilized, and server maintenance and management may be expensive for storing and managing information of the plurality of specified individuals.

According to the examples described above, a form document filling in method that can reduce the use of consumables such as paper and toner is provided because a writer does not need to print out the form document for filling-in. Further, inconvenience can be reduced since there is no need of filling in the same information in several fields. Also, a form document can be automatically completed by collecting information with respect to a plurality of unspecified individuals, and an image forming device using the same, can be provided.

Although examples have been described above, it will be understood by those of ordinary skill in the art that various changes in form and details may be made therein without departing from the spirit and scope as defined by the following claims.

What is claimed is:

1. An image forming device comprising:
a scanner to scan a form document to generate a document image; and
a processor to:
generate information data by converting written information with respect to at least one fill-out item of the form document into image data that can be written in the document image, and
generate final document image data by combining the information data with document image data based on the document image.

2. The image forming device of claim 1, wherein the processor is further to combine the information data with the document image data according to a location and a size of a fill-out field with respect to the at least one fill-out item.

3. The image forming device of claim 2, wherein the processor is further to extract the location and the size of the fill-out field with respect to the at least one fill-out item by analyzing the document image data.

4. The image forming device of claim 1, wherein the processor is further to:
convert a signature image into image data that can be written in the document image to generate signature data, and
overwrite the signature data to a document image data area that corresponds to a signature location and a signature fill-out area.

5. The image forming device of claim 4, wherein the processor is further to extract the signature location and the signature fill-out area by analyzing the document image.

6. The image forming device of claim 1, further comprising:
a user interface to receive the at least one fill-out item that requires writing of a writer and outgoing mail addresses from the form document; and
a mail server to send an outgoing mail that includes the at least one fill-out item to the outgoing mail addresses and to receive incoming mail responding to the outgoing mail.

7. The image forming device of claim 6,
wherein the processor is further to generate mail body information based on the at least one fill-out item, and
wherein the mail server is further to:
generate a body of the outgoing mail according to the mail body information to send a mail that includes the body to the outgoing mail addresses, and
transmit the incoming mail received from the outgoing mail addresses to the processor.

8. The image forming device of claim 6,
wherein the processor is further to extract an item that needs to be filled out by analyzing the document image data to generate a fill-out item list, and
wherein the at least one fill-out item is input among the fill-out item list through the user interface.

9. The image forming device of claim 6, wherein, when a signature request instruction is input through the user interface, the processor is further to:
generate signature data by converting a signature image included in the incoming mail to image data that can be written in the document image, and
overwrite the signature data to a document image data area that corresponds to a signature location and a signature fill-out area.

10. The image forming device of claim 6, further comprising a database to store fill-out item related data that relates to the document image data, a location and a size of a fill-out field of the at least one fill-out item, signature related data that relates to a signature location and a signature fill-out area of a signature in the form document, the image data and signature data with respect to a signature image, and the final document image data.

11. An image forming device comprising:
a memory; and
at least one processor to execute a program loaded in the memory,
wherein the program comprises instructions to:
generate a document image by scanning a form document,
receive written information with respect to at least one fill-out item of the form document,
generate information data by converting the written information to image data that can be written in the document image, and
generate final document image data by combining the information data with document image data based on the document image.

12. The image forming device of claim 11, wherein the program further comprises instructions to combine the information data with the document image data according to a location and a size of a fill-out field with respect to the at least one fill-out item.

13. The image forming device of claim 11, wherein the program further comprises instructions to:
when the form document needs to be signed, convert a signature image to image data that can be written in the document image to generate signature data, and
overwrite the signature to a document image data area corresponding to a signature location and a signature fill-out area.

14. The image forming device of claim 11, wherein the program further comprises instructions to:
generate mail body information based on the at least one fill-out item,
transmit the mail body information to a mail server,
receive incoming mail from the mail server, and
selectively extract written information that corresponds to the at least one fill-out item included in the incoming mail.

15. The image forming device of claim 11, wherein the program further comprises instructions to generate a fill-out item list by extracting items to be filled out by analyzing the document image data.
